(19) United States
(12) Patent Application Publication
(10) Pub. No.: US 2023/0385406 A1
(43) Pub. Date: Nov. 30, 2023

(54) RESPONSE SUPPORT DEVICE AND RESPONSE SUPPORT METHOD

(71) Applicant: Hitachi, Ltd., Tokyo (JP)

(72) Inventors: Naoki SHIMOTSUMA, Tokyo (JP); Mayuko TANAKA, Tokyo (JP); Tomohiro SHIGEMOTO, Tokyo (JP); Nobutaka KAWAGUCHI, Tokyo (JP); Katsuya NISHIJIMA, Tokyo (JP)

(21) Appl. No.: 18/120,446

(22) Filed: Mar. 13, 2023

(30) Foreign Application Priority Data
May 31, 2022 (JP) 2022-089309

(51) Int. Cl. G06F 21/55; G06F 21/57

(52) U.S. Cl. CPC G06F 21/552; G06F 21/577

(57) ABSTRACT

A response support technology for minimizing the impact on jobs as much as possible and enabling job continuity and prompt response can be realized. A response support device that supports a response executed according to a situation of an incident that has occurred in a monitoring target, includes an incident evaluation unit 103 that evaluates an impact of the incident on the monitoring target and an urgency level of the response against the incident; a response evaluation unit 104 that evaluates an impact level on jobs and an effectiveness level to the incident, for the response against the incident; a priority order determination unit 105 that determines a priority order of responses based on evaluation by the incident evaluation unit and evaluation by the response evaluation unit; and a display unit 106 that displays a screen including the priority order of responses determined by the priority order determination unit.

### CROSS-REFERENCE TO RELATED APPLICATION

The present application claims priority from Japanese application JP2022-089309, filed on May 31, 2022, the contents of which is hereby incorporated by reference into this application.

### TECHNICAL FIELD

The present invention relates to a response support device and a response support method, and more particularly to a support for making a suitable response determination for promptly responding to an incident such as a security breach event.

### BACKGROUND ART

Cases of cyberattacks affecting job continuity have been reported. For example, in a cyberattack on the automobile manufacturing industry, it was reported that the production control system was affected, production at a global base was stopped, and it took four days to fully restart the production. In addition, according to a survey by SANS, approximately 60% reported that it took more than 6 hours until the initial response. From these reports, it is important to shorten the initial response time in order to suppress the spread of damage caused by cyberattacks and maintain job continuity.

Various technologies have been proposed for monitoring incidents in target devices and systems and taking a response appropriately. For example, in PTL 1, a technology is disclosed in which the frequency of occurrence of each word included in the event information is calculated for each classified category, and in response to the reception of the new event, based on the words included in the event information of the new event and the calculated frequency of occurrence of each word, a category that includes the new event is estimated.

### CITATION LIST

### Patent Literature

PTL 1: JP2017-97781A

### SUMMARY OF INVENTION

### Technical Problem

In OT and IoT systems, prompt response is necessary because the social impact of the spread of damage is large. Furthermore, it is important to respond by considering the continuity and availability of job. For example, in the past, since the abnormal events and responses were determined in advance, depending on the operating situation of the system, such as the tightness of the information processing device (CPU) resources of the device in which abnormality is detected and the device that executes the response, although the impact level on jobs is high, it may take time to actually execute the response.

The technology of PTL 1 estimates, in response to reception of the new event, a category that includes a new event based on words included in the event information of the new event and the calculated frequency of occurrence of each word. Therefore, the responses are limited. For this reason, it is difficult to take responses that reflect the job and system situations at the time when an incident occurs, which change depending on the situation, such as the impact on jobs, the risk situation due to the incident, and the system status.

Accordingly, an object of the present invention is to realize a response support technology for minimizing the impact on jobs as much as possible and enabling job continuity and prompt response.

### Solution to Problem

According to a preferable example of the present invention, there is provided a response support device that supports a response executed according to a situation of an incident that has occurred in a monitoring target, the device including: an incident evaluation unit that evaluates an impact of the incident on the monitoring target and an urgency level of the response against the incident; a response evaluation unit that evaluates an impact level on jobs and an effectiveness level to the incident, for the response against the incident; a priority order determination unit that determines a priority order of responses based on evaluation by the incident evaluation unit and evaluation by the response evaluation unit; and a display unit that displays a screen including the priority order of responses determined by the priority order determination unit.

The present invention is also understood as a response support method performed by the response support device.

The present invention can also be understood as a response support program that realizes the functions of the response support device by being executed by a computer, and a medium that stores the program.

### Advantageous Effects of Invention

According to the present invention, a response support technology for minimizing the impact on jobs as much as possible and enabling job continuity and prompt response can be realized.

### BRIEF DESCRIPTION OF DRAWINGS

FIG. 1 is a diagram showing an example of a response support device according to one example.

FIG. 2 is a diagram showing an example of hardware of a response support device.

FIG. 3 is a diagram showing an example of a device information table.

FIG. 4 is a diagram showing an example of a job information table.

FIG. 5 is a diagram showing an example of a threat information table.

FIG. 6 is a diagram showing an example of a response information table.

FIG. 7 is a diagram showing an example of a response display screen.

FIG. 8 is a diagram showing an overall processing flow of the response support device.

FIG. 9 is a diagram showing a sequence of overall processing of the response support device.

FIG. 10 is a diagram showing a detailed processing flow of incident evaluation (step 805).

FIG. 11 is a diagram showing a detailed processing flow of response evaluation (step 806).

FIG. 12 is a diagram showing a detailed processing flow of priority order determination of responses (step 807).

### DESCRIPTION OF EMBODIMENTS

Hereinafter, preferable embodiments of the present invention will be described with reference to the drawings.

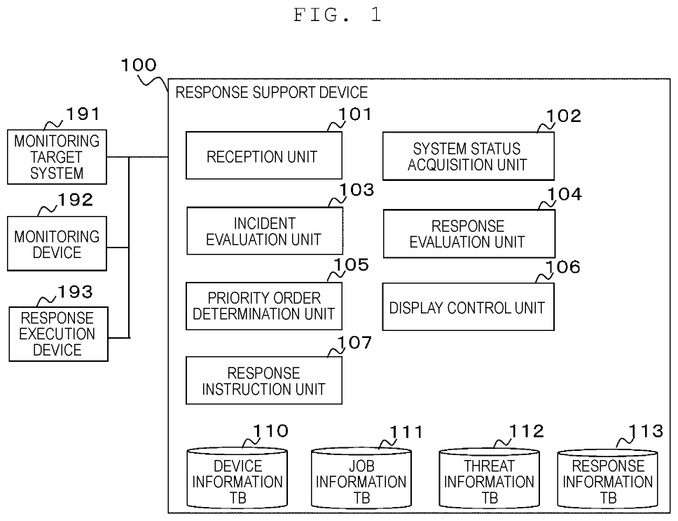

FIG. 1 shows an overall view of a system including a response support device according to one example.

A response support device 100 is connected to a monitoring target system 191, a monitoring device 192, and a response execution device 193 via a network to configure a system. In this system, the monitoring device 192 monitors an event that occurs in the monitoring target system 191, and the response execution device 193 takes a response according to the situation of the monitored event. The response support device 100 supports the responses executed by the response execution device 193.

First, these devices 191 to 193 will be briefly described. The monitoring target system 191 is, for example, a system including IT devices such as computers, printers, proxies, and routers, and IoT devices such as temperature sensors and acceleration sensors, and availability is particularly important. The monitoring device 192 is a resource monitor device, an anti-virus device, and the like for each device in the monitoring target system 191, and monitors the CPU usage rate of each device, whether or not the power supply is started, whether or not there is a network response, and whether or not there is a malware infection (incident). The response execution device 193 is, for example, an IDS/IPS, and when the monitoring device 192 detects an abnormality in the monitoring target system 191, automatically or according to the instruction of the operator, processing such as network isolation of devices and peripheral devices where abnormalities are detected, and deletion of malware-infected files is executed.

The response support device 100 includes a reception unit 101, a system status acquisition unit 102, an incident evaluation unit 103, a response evaluation unit 104, a response priority order determination unit 105, a display unit 106, a response instruction unit 107, a device information table 110, a job information table 111, a threat table 112, and a response information table 113 (the table is illustrated as “TB”).

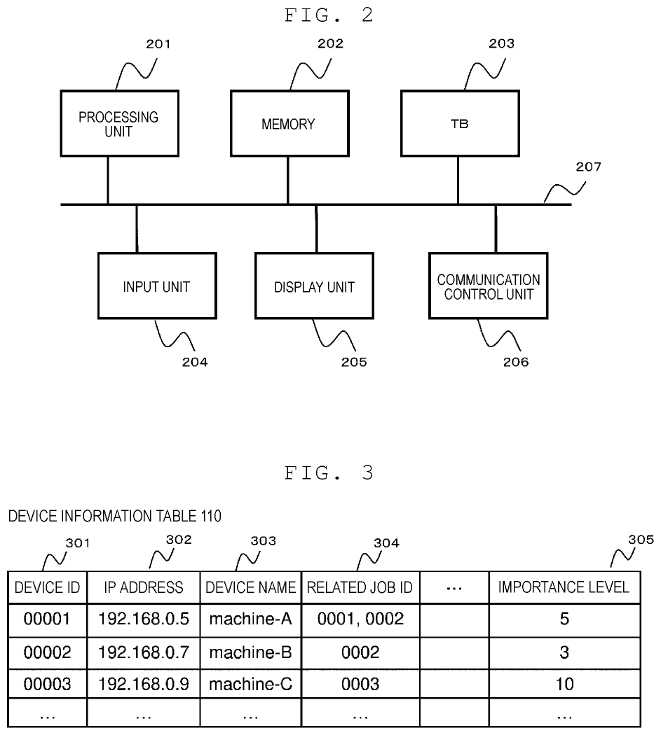

The reception unit 101 receives various information. Particularly, in the present example, the system status information of the monitoring target system 191 and the alert information transmitted by the monitoring device 192 are received. The alert information is issued when the monitoring device 192 detects that an incident such as malware infection or failure has occurred in the monitoring target system 191. The system status acquisition unit 102 acquires the system status information of the monitoring target system 191. The system status information includes, for example, resource devices that configure the monitoring target system 191, the addresses thereof, job processing situations in the devices, and the like, and these pieces of status information are used by the response support device 100 to determine the priority order of responses. Based on the alert information received by the reception unit 101, the incident evaluation unit 103 determines the impact of the incident on the monitoring target system 191 and the urgency level of the incident response. For each response against the incident, the response evaluation unit 104 determines the required time for responses, the impact level on jobs, and the effectiveness level to the incidents. The priority order determination unit 105 calculates the priority order of each response based on the evaluation result by the incident evaluation unit 103 and the evaluation result by the response evaluation unit 104. The display unit 106 performs processing of display information and screen display for a display unit 205 (FIG. 2). In the present example, in order to support the operator in making a prompt determination on a response, processing and display controls of a screen including the details and priority order of each response, selection items of the criteria of the prioritization, an update button for the prioritization information of the response, a response instruction button, and the like, are performed. The response instruction unit 107 transmits the details of responses determined by the operator on the screen displayed on the display unit 106 to the response execution device 193.

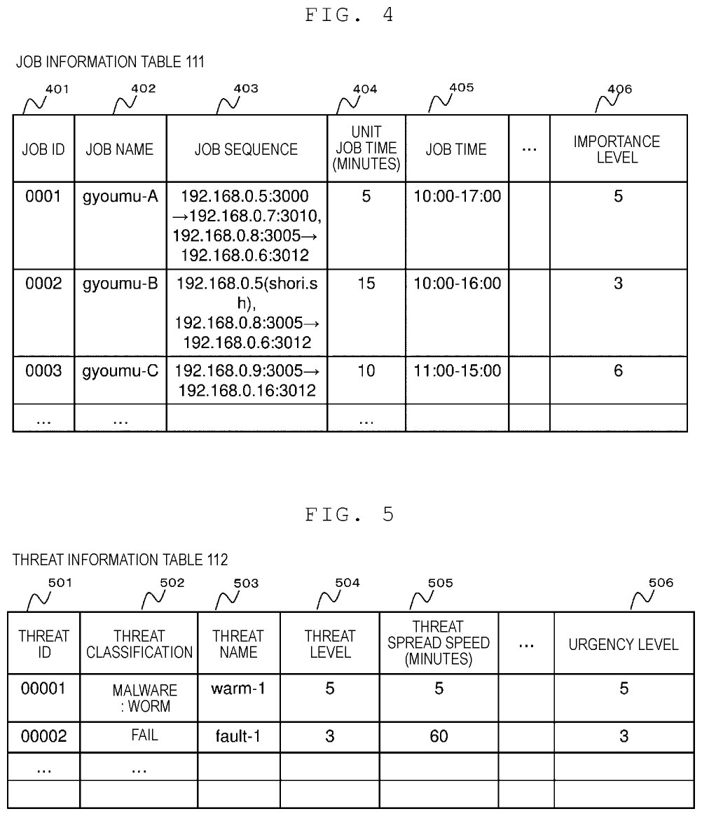

The functions of the respective units 101 to 107 described above are realized by executing programs on the CPU 201 in FIG. 2. In addition, each of the tables 110 to 113 is stored in a memory 202 or a storage unit 203 in FIG. 2. The configuration of each table will be described later with reference to FIGS. 3 to 6.

FIG. 2 shows a configuration example of hardware of a computer applied to the response support device 100.

The computer is configured by connecting the processing unit 201, the memory 202, the storage unit 203, an input unit 204, the display unit 205, and a communication control unit 206 via a bus 207. The processing unit 201 executes a program to realize each functional unit shown in FIG. 1. The memory 202 and the storage unit 203 store data acquired by the reception unit 101, various data used by the processing unit 201, and various programs including programs for realizing each of the above functional units. The input unit 204 is information input equipment such as a keyboard and a mouse. The display unit 205 is, for example, a display such as a liquid crystal display. The communication control unit 206 is communication control means for communicating with, for example, a wireless network interface, a network interface card, or the like.

Next, configuration examples of each table will be described with reference to FIGS. 3 to 6.

FIG. 3 shows an example of the device information table 110.

The device information table 110 manages information on each device that configures the monitoring target system 191. Specifically, a device ID 301 that uniquely distinguishes each device, a device IP address 302, a device name 303, a related job ID 304 to which the device is related in a job, a device importance level 305, and the like are stored. For example, a device with the device ID 301 of “00001” has the IP address 302 of “192.168.0.5”, the device name 303 of “machine-A”, the related job ID 304 of “0002” and “0003”, and the device importance level 305 of “5” when the importance level is managed in ascending order from 1 to 10, for example.

Here, the device importance level 305 means the importance level when the device executes the related job. Calculation of the information stored by the device may be included in the importance level. For example, in the processing of a certain factory assembly job, when the machine A is a machine that issues instructions to the machines B to D and the machines B to D are machines that follow the instructions from the machine A to attach parts to predetermined positions and perform various operations, when the machine C and the machine A malfunction, the machine C is complemented by other machines B and D, but when the machine A malfunctions, the machines B and D cannot complement the processing of the machine A. In addition, since the machine A also includes instruction command information that can instruct the machines B to D to perform malicious operations, it can be assumed that the machine A has a higher importance level than that of the machines B to D.

FIG. 4 shows an example of the job information table 111.

The job information table 111 manages information on jobs executed by the monitoring target system 191. Specifically, a job ID 401 that uniquely distinguishes each job, a job name 402, a job sequence 403 that indicates inter-device communication of a series of job processing and intra-device processing details, a unit job time 404 required for processing the job sequence 403, a job time 405 which is a time zone in which a job can be executed, a job importance level 406, and the like are stored.

For example, since a job with the job ID 401 of “00001” has the job name 402 of “gyoumu-A” and the job sequence 403 of “192.168.0.5:3000-192.168.0.7:3010, 192.168.0.8:3005-192.168.0.6:3012”, in a job sequence in which communication from IP and Port 192.168.0.5:3000 to 192.168.0.7:3010 and communication from 192.168.0.8:3005 to 192.168.0.6:3012 configure a series of unit jobs, the unit job time 404 is “5” minutes, the job time 405 during which the job may occur is the time zone from “10:00 to 17:00”, and the job importance level 406 is “5” when the importance level is managed in ascending order from 1 to 10, for example.

Here, regarding the job importance level, for example, in processing at a chemical plant, a job 1 for mixing the chemicals A and B to cause a chemical reaction to produce the chemical X, and a job 2 for diluting the chemical C to produce the chemical C′ are assumed as a certain chemical plant. In this case, it is assumed that there is processing in which strictness is required for the mixing ratio of the chemicals A and B, and this mixing operation wastes the production of the chemicals X, which has a high unit price, and the damage cost is high. In addition, processing in which, even when there is a slight percentage error in the dilution processing of the chemical C, the production of the chemical C′ itself is not affected much (recoverable), and even when the production of a certain number of chemical C′ fails, the damage cost is not as high as that of the chemical X, is assumed. In this case, it is assumed that the importance level of the production processing job of the chemical X is “higher”.

Note that the device information table 110 and the job information table 111 register, update, and delete information in each table at the timing of, for example, the introduction or disposal of devices by the system administrator, and the addition or deletion of new job information associated therewith.

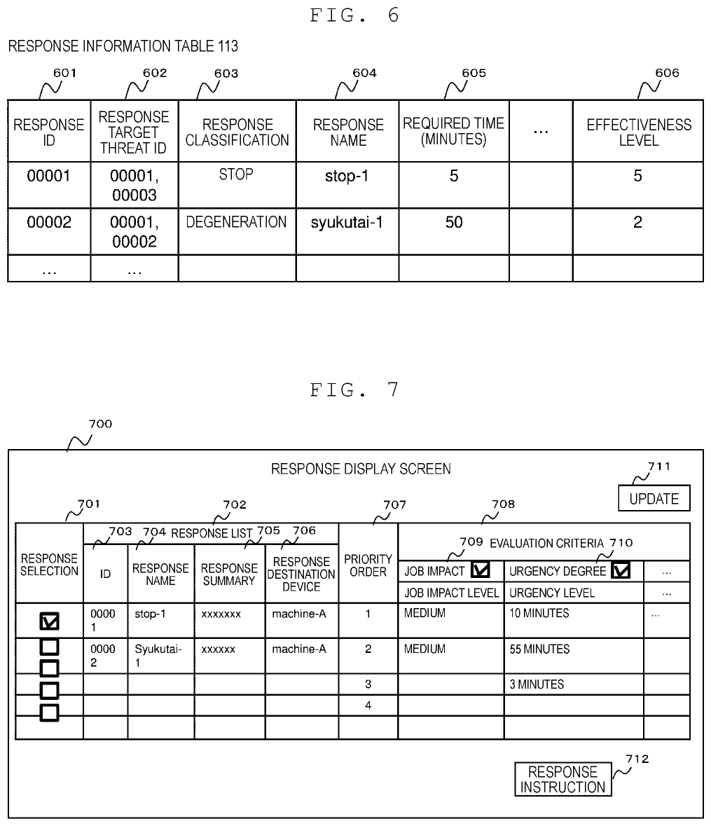

FIG. 5 shows an example of the threat information table 112.

The threat information table 112 manages threat information of incidents detected by the monitoring device 192. Specifically, a threat ID 501 that uniquely distinguishes each piece of threat information, a threat classification 502 that classifies the type of threat, a threat name 503, a threat level 504 that indicates the impact degree of the threat on jobs and systems, a threat spread speed (minutes) 505 that indicates the degree of the speed at which a threat propagates to other devices and the like, an urgency level 506 defined in advance from the impact of a threat, the threat spread speed and the like, and the like are stored.

For example, the threat with the threat ID 501 of “00001” has the threat classification 502 of “malware” and “worm”, the threat name 503 of “warm-1”, the threat level 504 of “5” when the importance level is managed in ascending order from 1 to 10, the threat spread speed 505 of “5” minutes, and the urgency level of “5” when the importance level is managed in ascending order from 1 to 10.

In addition, as for the threat ID 501, in the present example, the monitoring device 192 transmits the alert information including a predetermined ID, and the reception unit 101 receives and stores this in the threat information table. However, when cooperating with the monitoring device 192 provided by a plurality of companies, the correspondence relationship between the alert information and the threat ID may differ depending on the plurality of companies. Thus, there is a case where an association unit between the alert information output by the monitoring device 192 and each element of the threat information table including the threat ID is prepared between the monitoring device 192 and the reception unit 101.

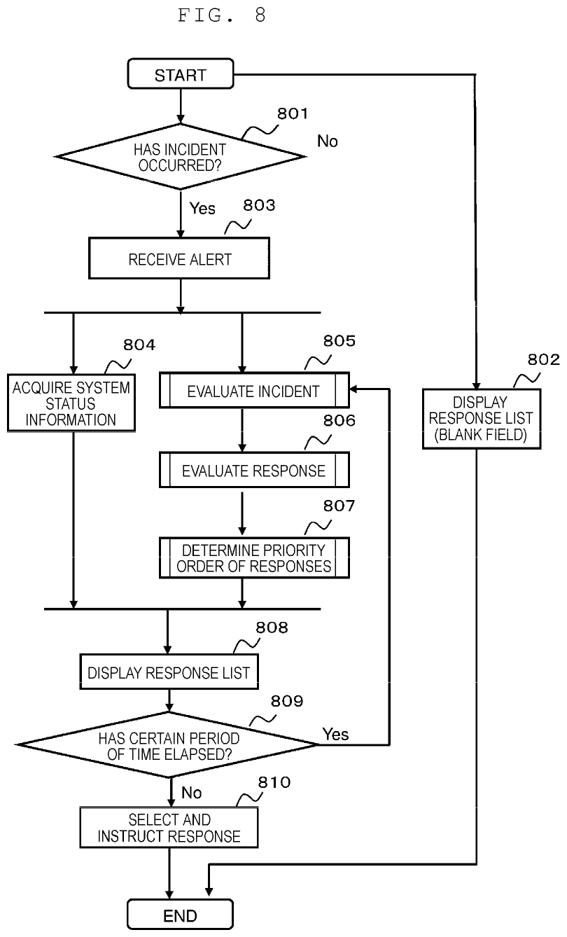

FIG. 6 shows an example of the response information table 113.

The response information table 113 manages the details of responses for incidents. Specifically, a response ID 601 that uniquely distinguishes each response, a response target threat ID 602 that identifies the threat which is the response target, a response classification 603 that classifies the response type, a response name 604, a required time 605 that indicates a guideline of the required time for which the response is executed and the effectiveness on incidents is expected, an effectiveness level 606 that indicates the effectiveness degree of the response against the incident, and the like are stored.

For example, a response with the response ID 601 of “00001” has the threat ID 602 of “00001” and “00003”, which are response targets, the response classification of “stop”, the response name of “stop-1”, the guideline of the required time, for which the response is executed and the effectiveness on incidents is expected, of “5” minutes, and the effectiveness degree of the response of “5” when the importance level is managed in ascending order from 1 to 10.

Based on each of the above tables, the response support device 100 performs incident evaluation and response evaluation based on the alert information received from the monitoring device 192, and prioritizes responses.

The threat information table 112 and the response information table 113 register, update, and delete each piece of table information, for example, at the timing when the manufacturer of the response support device according to the present example or the security administrator who is the user of the response support device updates the security threat information.

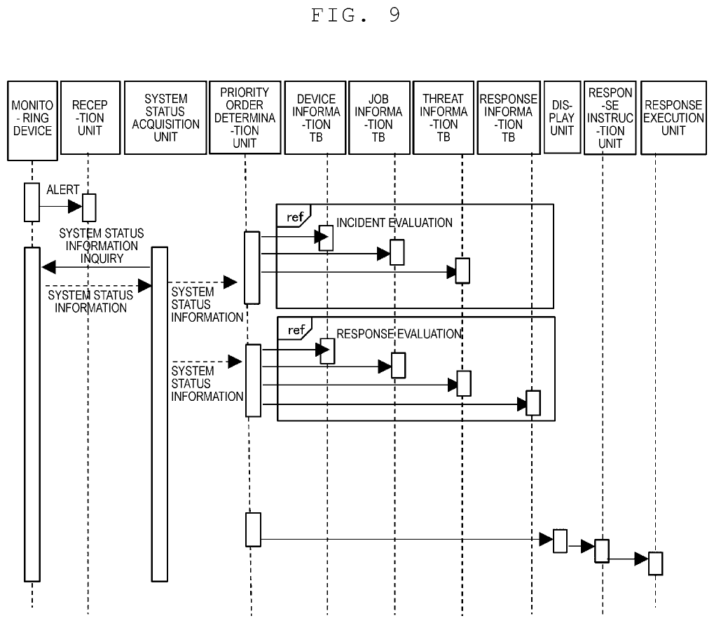

Next, an example of a response display screen will be described with reference to FIG. 7.

The display unit 205 displays a response display screen 700 including details of responses against the prioritized incidents. Specifically, the response display screen 700 includes a response selection field 701 from which the operator can select a response, a response list 702 that displays a list of responses against incidents, a priority order 707 that indicates the priority order of each response, evaluation criteria 708 for selecting the criteria of prioritization of responses and the application thereof, an update button 711 for reloading and displaying the details of the response list when the prioritization changes in real time, and a response instruction button 712. According to this example, a plurality of responses can be provided for one incident, and the operator can select the response determined to be most optimal. That is, when the operator selects “response” in the response selection 701 and presses the response instruction button 712, the selected response is transmitted to the response execution device 193.

Further, the response list 702 has a response ID 703, a response name 704, a response summary 705 for explaining the response classification and summary to the operator, and a response destination device 706 that indicates the response destination device. Here, the response ID 703 and the response name 704 are the same as the response ID 601 and the response name 604 in the response table 113. In addition, the evaluation criteria 708 have a job impact 709 and a promptness degree 710. The job impact 709 further has a selection box for determining whether or not to include the job impact in the evaluation criteria items to calculate the prioritization of responses, and a display of the job impact level that indicates the degree of the job impact. The promptness degree 710 further has a display of a selection box for whether or not to include the promptness degree in the evaluation criteria items to calculate the prioritization of responses, and the promptness degree that indicates the degree of required time expected to observe the effectiveness of the response against the threat.

The response support device according to the present example uses the display screen to support the operator in making a determination on response.

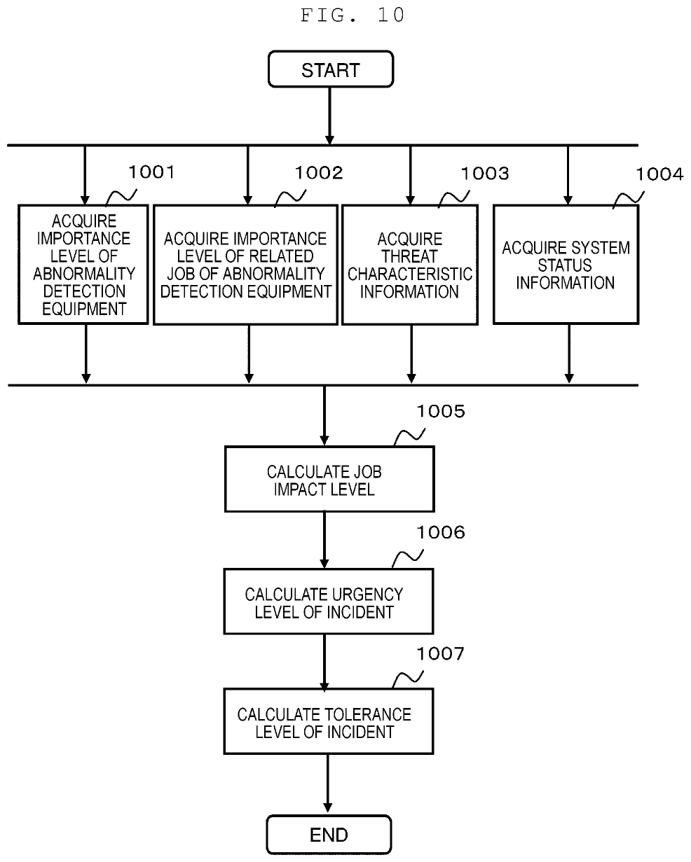

Next, with reference to FIGS. 8 and 9, the overall processing of the response support device 100 will be described.

FIG. 8 shows the overall operation of the response support processing, and FIG. 9 shows the sequence of the processing when an incident occurs.

With reference to FIG. 8, first, the monitoring device 192 determines whether or not an incident has occurred in the monitoring target system 191 (step 801). When the monitoring device 192 does not detect an incident in the monitoring target system 191, the details of the response list are not displayed on the display unit 106 (that is, the response list remains blank), and the processing ends (step 802).

On the other hand, when the monitoring device 192 detects an incident in the monitoring target system 191, the monitoring device 192 transmits the alert information, which is received by the response support device 100 (step 803). After that, the processing of steps 804 to 810 is continued. This corresponds to alert notification from the monitoring device 192 to the reception unit 101 in the response support device 100 in the sequence of FIG. 9.

Next, the system status acquisition unit 102 of the response support device 100 inquires the monitoring device 192 and acquires the system status information of the monitoring target system 191 (step 804). The system status information includes the job communication situation of the monitoring target system 191, the start/stop situation of the device and peripheral equipment where incidents were detected, the resource situation such as CPU load and memory load, and the like. The system status acquisition unit 102 continues to acquire the system status information while the display unit 106 displays the response list screen and the response selection and the response execution are performed. This corresponds to the transmission of the system status information inquiry and system status information from the monitoring device 192 to the system status acquisition unit 102 in the sequence of FIG. 9.

Next, based on the alert information acquired in step 803, the system status information acquired in step 804, and the information in each of the tables 110 to 113, the priority order of responses is determined (steps 805 to 807).

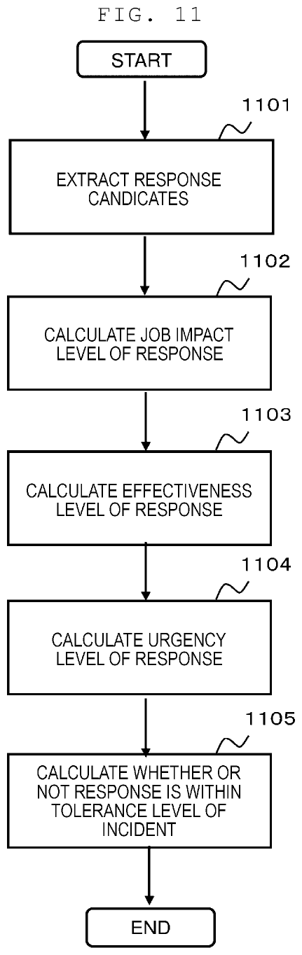

In step 805, based on information such as the alert information, the system status information, the device storage table 110, the job information table 111, and the threat information table 112, the impact level of the incident on jobs and the urgency level of the response are calculated. This corresponds to the block part in the sequence of FIG. 9 in which the response priority order determination unit inquires various tables and evaluates the incident. The details of this processing will be described later with reference to the processing flow of incident evaluation in FIG. 10.

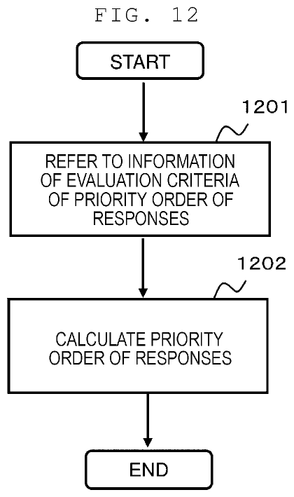

In step 806, based on information such as the alert information, the system status information, the device storage table 110, the job information table 111, the threat information table 112, and the response information table 113, the effectiveness level, the job impact level, the promptness level, and the like of the response are calculated. This corresponds to the block part in the sequence of FIG. 9 in which the response priority order determination unit inquires various tables and evaluates the response. The details of this processing will be described later with reference to the processing flow of response evaluation in FIG. 11.

In step 807, based on the results calculated in steps 805 and 806 and the information of the response evaluation criteria 708 selected by the operator on the response display screen 700 or preset by the response support device 100, the priority order of responses is calculated. This corresponds to the lowermost block part of the response priority order determination unit in the sequence of FIG. 9. The details of this processing will be described later with reference to the processing flow for determining the priority order of responses in FIG. 12.

Next, the display unit 106 displays a list of prioritized responses which are calculated by the priority order determination unit 105 (step 808). In addition, when a certain period of time has elapsed because the operator took time to consider the determination to take response, the impact of the incident on jobs, the resource situation of the response destination device, and the status of the job that may be affected by the response also change, and thus, for example, the processing of steps 804 to 808 is executed again after a certain period of time has elapsed (step 809).

Next, when the operator selects a response to be actually executed from the response list screen displayed on the display unit 106 (701) and presses the response instruction 712, the response instruction unit 107 transmits the response instruction information to the response execution device 193 (step 810). The response execution device 193 executes responses in accordance with the received response details, and the series of response processing ends.

FIG. 10 shows an example of a detailed processing flow of incident evaluation (step 805).

An object of this processing is to calculate the job impact level, the urgency level, and the like in order to first extract responses according to the impact of the incident, that is, the job impact level and the urgency level of the response, and proceed the processing, when prioritizing the responses.

The incident evaluation unit 103 first acquires the importance level of the equipment in which an abnormality has been detected, which is a component of the calculation of the incident evaluation (step 1001), acquires the importance level of the related job of the equipment in which the abnormality has been detected (step 1002), acquires the threat characteristic information (step 1003), and acquires the system status information (step 1004).

Specifically, when the abnormality detection equipment ID received from the alert information is “00001”, with reference to the device information table 110, it can be seen that the importance level 305 of the equipment corresponding to the abnormality detection equipment ID 301 of “00001” is “5”. In addition, since the related job 304 of the equipment is “0001, 0002”, with reference to the job information table 111, it can be seen that the importance level 406 of the job corresponding to the related job ID 401 of the abnormality detection equipment of “0001” and “0002” is “5” and “3”. In addition, when the threat ID received from the alert information is “00001”, with reference to the threat information table 112, it can be seen that the threat level 504 corresponding to the threat ID 501 of “00001” is “5”, and the urgency level 506 is “5”. Further, based on the abnormality detection time included in the alert information, the operating status of the abnormality detection equipment received from the system status information, the job communication information, and the like, it can be seen that the time when the abnormality was detected is “11:00”, either “00001” or “00002” of the job ID 401 is within the job time 405, the abnormality detection equipment is in the operating status without system down, communication of “192.168.0.5:3000-192.168.0.7:3010” and “192.168.0.5 (shori.sh)” is occurring as a job communication situation, and the communication situation is immediately after the start of each job sequence in the job sequence 403 of each row of the corresponding job ID 401.

Next, based on each piece of the information acquired in steps 1001 to 1004, the impact level of the incident on jobs is calculated (step 1005). The impact level on the job is, for example, the result obtained by adding the importance level of the abnormality detection equipment, the importance level of the job related to the abnormality detection equipment and in operation, and the threat level of the detected threat. There is also a method of performing addition after weighting the equipment importance level, the job importance level, and the threat level values, but in the present example, all weights are added as “1” for the sake of simplification of explanation. Specifically, when the abnormality detection equipment ID is “00001”, the importance level 305 of the equipment is “5”, the importance level 406 of job is “8” that is obtained by adding “5” and “3” of the importance level 406 of each job since the time when the abnormality was detected is “11:00” and is within the job time 405 of the related job ID “0001” and “0002”, the threat level 504 is “5” and the urgency level 506 is “5” since the threat ID 501 is “0001” according to the threat information acquired from the alarm information, and the result of “18” is obtained by adding the above asset importance level “5”, the job importance level “8”, and the threat level “5”.

Next, based on each piece of the information acquired in steps 1001 to 1004, the urgency level of the response against the incident is calculated (step 1006). The urgency level of the response against the incident is, for example, the result obtained by adding the importance level of the abnormality detection equipment, the importance level of the job related to the abnormality detection equipment and in operation, and the threat level of the detected threat. Specifically, when the abnormality detection equipment ID is “00001”, the time when the abnormality was detected is “11:00”, and the threat ID is “0001”, the result of “18” is obtained, similar to step 1005, by adding the asset importance level “5”, the job importance level “8” and the urgency level 506 “5” of the detected threat.

Finally, the incident tolerance level is calculated (step 1007). The incident tolerance level is a value for determining whether the impact level on the job calculated in step 1005 or step 1006 or the urgency level of response against the incident is equal to or less than a preset tolerance level threshold value. Further, when the impact level on the job and the urgency level of the response against the incident calculated in steps 1005 and 1006 exceed the preset tolerance level threshold value, it is necessary to take a response as soon as possible, and thus, in the prioritization of subsequent responses, the weighting of the job impact level is calculated as “0”. Specifically, when the impact level on the job is “18”, the urgency level of the response against the incident is “18”, the preset tolerance level threshold value is “20” for the impact degree on the job, and the preset tolerance level threshold value is “15” for the urgency degree of the response against the incident, both the job impact level and the incident urgency level are below the threshold values of the tolerance level of the impact degree and the urgency degree of the response against the incident, and thus it is assumed that the calculation is performed as it is in the prioritization of the subsequent responses. In addition, when an incident with the threat ID 501 “00001” is detected at time “11:30” with the device ID 301 “00003”, the threat level 504 of the threat ID 501 “00001” is “5”, the importance level of the detected device ID 301 “00003” is “10”, and the importance level 406 of the job ID 401 “0003”, which is a related job in operation, is “6”, and thus the result obtained by adding each value is “21”. Since this exceeds the tolerance level of the job impact level of “20”, calculation is performed while the weighting of job impact level is “0” when prioritizing subsequent responses, and response candidates with higher promptness level are given higher priority order regardless of the degree of job impact level.

With the above, the processing of the incident evaluation unit 103 ends.

FIG. 11 shows an example of a detailed processing flow of response evaluation (step 806).

An object of this processing is to calculate the effectiveness level, the promptness level or the like of the responses which are targets of the evaluation criteria for prioritizing the responses, when prioritizing the response.

The response evaluation unit 104 first extracts a list of responses corresponding to the threat ID 602 of the incident (step 1101). With reference to the threat ID information included in the alert information and the response information table 113, an item corresponding to the response target threat ID 602 is extracted. Specifically, rows that are included in the column of the response target threat ID 602 with the threat ID of “00001” are extracted, and the responses with the values of the response ID 601 of “00001” and “00002” are extracted.

Next, for each of the extracted response candidates, the impact level on the job when the responses are executed is calculated (step 1102). The job impact level when the response is executed is, for example, the result obtained by adding the degree of job impact pre-assigned for each response classification of response candidates and the importance level of the job that is related to the abnormality detection equipment and the response instruction destination equipment and is in operation, with reference to the device information table 110, the job information table 111, and the response information table 113. Note that each element of this addition may be weighted before addition. In the present example, all weights are added as “1” for the sake of simplification of explanation. Specifically, for the response with the response ID 601 “00001” and the response name 604 “stop-1”, which is one of the response candidates, the pre-assigned job impact degree is “5” since the response classification 603 is “stop”, the importance level 305 of the device corresponding to the same device ID 301 “00001” of the abnormality detection equipment and the response instruction destination equipment is “5”, each of the importance degrees 406 is “5” and “3” of each job since the related job ID 304 is “0001, 0002” and the time when the abnormality was detected is “11:00” and is within the job time 405 of the related job ID “0001” and “0002” and the result of “18” is obtained by adding the job impact degree “5” pre-assigned to the response classification 603 “stop”. Similarly, calculation is performed for the response ID 601 “00002” and the response name 604 “syukutai-1”, which is one of the response candidates. For the response with the response ID 601 “00002” and the response name 604 “syukutai-1”, since the response classification 603 is “degeneration”, the pre-assigned job impact degree is “3”, and the result of “14” is obtained.

Next, for each of the extracted response candidates, the effectiveness level of responses against incidents when responses are executed is calculated (step 1103). For example, the effectiveness level of the response is the result obtained from the value of the effectiveness level 606 with reference to each row corresponding to the response candidate extracted from the response information table 113. Specifically, for the response with the response ID 601 “00001” and the response name 604 “stop-1”, which is one of the response candidates, the result of “5” is obtained with reference to the effectiveness level 606. Similarly, for the response with the response ID 601 “00002” and the response name 604 “syukutai-1”, which is one of the response candidates, the result of “2” is obtained with reference to the effectiveness level 606.

Next, for each of the extracted response candidates, the promptness level of the response against the incident when the response is executed is calculated (step 1104). The promptness level of the response is, for example, the result obtained by adding the value of the required time 605 and the response execution waiting time, which was calculated from the unit job time and the progress situation of the job sequence of the job that is related to the response instruction destination equipment and is in operation, and by descending from the value “10” out of 10 steps every 10 minutes, with reference to each of the rows corresponding to the response candidates extracted from the response information table 113. Specifically, for the response with the response ID 601 “00001” and the response name 604 “stop-1”, which is one of the response candidates, it is determined whether or not the job ID 401 “0001” and “0002”, which are related to the device ID “00001” that is the response instruction destination equipment and is in operation, are in operation. When it is determined that the job ID 401 “0001” and “0002” are in operation, when there is a job with an importance level equal to or higher than the pre-assigned threshold value “4”, which is the threshold value for determining whether or not to wait for the execution of responses, after the job sequence of the job ends, that is, a value of “10” is obtained by adding “5”, which is the required time (minutes) 605 of the corresponding response ID 601 “00001” and the response name 604 “stop-1”, to the maximum unit job time, and this obtains the result of a value “10” in descending order from the value “10” out of ten steps every 10 minutes.

Finally, it is calculated whether or not each of the extracted response candidates is within the tolerance levels of the impact degree and the urgency degree of the response against the incident (step 1105). For example, for each of the extracted response candidates, when the job impact level and the promptness level of the response when the response is executed, which were calculated in steps 1102 and 1104, exceed the impact level on each of the pre-assigned jobs, a minus point is obtained for the difference, and when the promptness level is below the urgency level, a minus point is obtained for the difference. In cases other than the above, it is assumed that the impact degree and the urgency degree of the response against the incident are within the tolerance level, and the values of the job impact level and the promptness level of the response when the response is executed, which were calculated in the processing of steps 1102 and 1104, are used as they are for prioritizing the responses described in the subsequent processing. Specifically, for the response with the response ID 601 “00001” and the response name 604 “stop-1”, which is one of the response candidates, the job impact degree “18” calculated in step 1102 is below the threshold value “20” of the pre-assigned job impact level, and thus the value “18” is obtained as it is. Subsequently, the promptness level “10” of the response against the incident calculated in step 1104 exceeds the maximum value “5” among the urgency levels of each threat, and thus the value “10” is obtained as it is. Similarly, when the response with the response ID 601 “00002” and the response name 604 “syukutai-1”, which is one of the response candidates, was calculated, the job impact degree remains “14” calculated in step 1102, and regarding the promptness level of the response against the incident, “4” calculated in step 1104 exceeds the maximum value “5” among the urgency levels of each threat, and thus the result of “3” obtained by subtracting 1 point from “4” calculated in step 1104 is obtained.

FIG. 12 shows a detailed processing flow of priority order determination of responses (step 807).

The priority order determination unit 105 first refers to the information of the evaluation criteria 708 of the response selected by the operator on the response display screen 700 or preset by the response support device 100 (step 1201). For example, when there are items selected from the job impact and promptness degree of the response, which are evaluation criteria, or other criteria, they are referred to as items that form the basis of evaluation criteria for prioritization of responses. In addition, regarding the effectiveness level of responses, it is assumed that the effectiveness of any response extracted for the threat is guaranteed, and is not included in the options for the evaluation criteria items. Specifically, in the evaluation criteria 708 of the response display screen 700, the check boxes for the job impact 709 and the promptness degree 710 are checked (example in FIG. 7), and these two criteria are referred to as items that form the basis of evaluation criteria for prioritization of responses.

Next, the priority order of responses is calculated and the processing ends (step 1202). That is, based on the information of the evaluation criteria 708 of the responses, the priority order of the responses is calculated (step 1201) For example, it is assumed that the job impact and the promptness degree of the response are selected as the evaluation criteria, responses are prioritized based on the evaluation values calculated in the processing of incident evaluation (step 805) and response evaluation (step 806). Specifically, for the response with the response ID 601 “00001” and the response name 604 “stop-1”, which is one of the response candidates, based on the job impact and the promptness degree of response as the evaluation criteria, which is the selected evaluation criteria item, with reference to the evaluation values calculated in the processing of the incident evaluation (step 805) and the response evaluation (step 806), the result that the job impact degree is “18” and the promptness level of the response against the incident is “10” is obtained. Similarly, for the response with the response ID 601 “00002” and the response name 604 “syukutai-1”, which is one of the response candidates, similarly, with respect to the evaluation values, the result that the job impact degree is “14” and the promptness level of response against the incident is “3” is obtained. Here, as described in the description (FIG. 11) of the processing of response evaluation (step 806), in both of the response names 604 “stop-1” and “syukutai-1”, the pre-assigned job impact level is below the threshold value “20” and within the allowable range of impact on jobs. The evaluation value of the promptness level of the response against the incident is higher in the response “stop-1”, and the effectiveness level of the response also exceeds that of the “syukutai-1”. Therefore, the priority order of responses is “stop-1”, followed by “syukutai-1”. Similarly, as a result of calculating other response candidates, a list of prioritized response candidates can be displayed as shown in a response display screen 700 in FIG. 7.

As described above, according to the present example, based on the system status information and the analysis result of the detected event, the job impact level, the promptness degree, the effectiveness degree, and the necessary resources are calculated in an integrated manner, and the responses can be prioritized and presented to the operator. As a result, it is possible to reduce the impact on jobs, and to realize response promptness and job continuity. In addition, it is possible to shorten the time required for the operator to determine a response against the system abnormality.

In addition, according to the present example, taking into account system status information such as system operating situation that changes in real time, it is possible to reflect the opportunity to select a response candidate that has a short actual response execution time and a low job impact level in the response support.

The present invention is not limited to the above example, and can be realized in various modifications and substitutions.

For example, in the above example, the functional units 101 to 107 of the response support device 100 are realized by executing the computer program shown in FIG. 2. According to another example, one or more functions of a part of each of the functional units 101 to 107 may be realized by executing a program on one or more computers. Further, it is not necessary to realize all of the above functional units by executing one program. Each of the above functional units may be realized by separate programs, or several functional units may be integrated into one program. For example, the incident evaluation unit 103, the response evaluation unit 104, and the priority order determination unit 105, which are characteristics of the present example, may be realized by being integrated into one program.

In addition, the various functional units of the response support device of the present example may be integrated into the response execution device to integrally configure both devices. In this case, the integrated device may be called a response execution device.

In addition, instead of calling each of the information tables 110 to 113 a table as in the present example, the device may be called a database (DB), or simply their information or information structure, or their storage unit.

Note that the monitoring target is not limited to a monitoring target system including a plurality of equipment, and may be the sensor itself.

### REFERENCE SIGNS LIST

100: response support device
101: reception unit
102: system status acquisition unit
103: incident evaluation unit
104: response evaluation unit
105: priority order determination unit
106: display unit
700: response display screen
107: response instruction unit
110: device information table
111: job information table
112: threat information table
113: response information table
191: monitoring target system
192: monitoring device
193: response execution device

1. A response support device that supports a response executed according to a situation of an incident that has occurred in a monitoring target, the device comprising:
an incident evaluation unit that evaluates an impact of the incident on the monitoring target and an urgency level of the response against the incident;
a response evaluation unit that evaluates an impact level on jobs and an effectiveness level to the incident, for the response against the incident;
a priority order determination unit that determines a priority order of responses based on evaluation by the incident evaluation unit and evaluation by the response evaluation unit; and
a display unit that displays a screen including the priority order of responses determined by the priority order determination unit.

2. The response support device according to claim 1, wherein
the monitoring target is a system (monitoring target system) in which jobs are performed by operating a plurality of devices,
an acquisition unit that acquires system status information of the monitoring target system is provided,
the acquisition unit continuously acquires the system status information during a period when the incident evaluation unit, the response evaluation unit, and the priority order determination unit are being executed, and
the incident evaluation unit and the response evaluation unit evaluate each in consideration of the job in operation included in the system status information acquired by the acquisition unit.

3. The response support device according to claim 1, wherein
the monitoring target is a system (monitoring target system) in which jobs are performed by operating a plurality of devices,
a storage unit that pre-stores information on each device that configures the monitoring target system, information on jobs executed in the monitoring target system, threat information of incidents detected by a monitoring device, and information on details of responses is provided, and
the incident evaluation unit, the response evaluation unit, and the priority order determination unit use the information stored in the storage unit to perform evaluation and determination.

4. The response support device according to claim 3, wherein
the storage unit stores
a device information table for managing the information on each device that configures the monitoring target system,
a job information table for managing the information on jobs executed in the monitoring target system,
a threat information table for managing the threat information of incidents detected by the monitoring device, and
a response information table for managing the details of the responses, and
the incident evaluation unit, the response evaluation unit, and the priority order determination unit refer to each of the information tables to perform evaluation and determination.

5. The response support device according to claim 1, wherein
the display unit displays a screen including a response selection field from which an operator is capable of selecting a response, a response list that displays a list of responses against incidents, a priority order that indicates a priority order of responses, and evaluation criteria for selecting criteria of prioritization of responses and application thereof.

6. The response support device according to claim 5, wherein
the screen has a response instruction button operated by the operator,
when the operator selects a response in the response selection field and operates the response instruction button, the response instruction unit transmits the selected response to a response execution device.

7. The response support device according to claim 6, wherein
the screen has an update button for reloading and displaying details of the response list when the prioritization changes in real time, and
the display unit displays the screen including the response list when the operator operates the update button or automatically at regular intervals.

8. A response support method for supporting a response executed by a computer according to a situation of an incident that has occurred in a monitoring target, the method comprising:
an incident evaluation step of evaluating an impact of the incident on the monitoring target and an urgency level of the response against the incident;
a response evaluation step of evaluating an impact level on jobs and an effectiveness level to the incident, for the response against the incident;
a priority order determination step of determining a priority order of responses based on evaluation in the incident evaluation step and evaluation in the response evaluation step; and
a display step of displaying a screen including the priority order of responses determined in the priority order determination step, on the display unit.

9. The response support method according to claim 8, wherein
the monitoring target is a system (monitoring target system) in which jobs are performed by operating a plurality of devices,
an acquisition step of acquiring system status information of the monitoring target system is provided,
in the acquisition step, the system status information is continuously acquired during a period when the incident evaluation step, the response evaluation step, and the priority order determination step are being executed, and
in the incident evaluation step and the response evaluation step, evaluation is performed each in consideration of the job in operation included in the system status information acquired in the acquisition step.

10. The response support method according to claim 8, wherein
the monitoring target is a system (monitoring target system) in which jobs are performed by operating a plurality of devices,
a step of pre-storing information on each device that configures the monitoring target system, information on jobs executed in the monitoring target system, threat information of incidents detected by a monitoring device, and information on details of responses, in a storage unit, is provided, and
in the incident evaluation step, the response evaluation step, and the priority order determination step, the information stored in the storage unit is used to perform evaluation and determination.

11. The response support method according to claim 8, wherein
the display unit displays a screen including a response selection field from which an operator is capable of selecting a response, a response list that displays a list of responses against incidents, a priority order that indicates a priority order of responses, and evaluation criteria for selecting criteria of prioritization of responses and application thereof, and
when the operator selects a response in the response selection field and operates the response instruction button, the response instruction unit transmits the selected response to a response execution device.

12. The response support method according to claim 11, wherein
after a certain period of time has elapsed, the incident evaluation step, the response evaluation step, and the priority order determination step are repeatedly executed.
